(19) United States
(12) Patent Application Publication
(10) Pub. No.: US 2023/0206774 A1
(43) Pub. Date: Jun. 29, 2023

(54) METHOD AND SYSTEM FOR ASSISTING WITH THE APPROACH OF AN AIRCRAFT WITH A VIEW TO LANDING

(71) Applicant: THALES, COURBEVOIE (FR)

(72) Inventors: Johan BOYER, TOULOUSE (FR); Sabine TAINTURIER, TOULOUSE (FR); Geoffrey DURAND, TOULOUSE (FR)

(21) Appl. No.: 17/927,683

(22) PCT Filed: May 25, 2021
(86) PCT No.: PCT/EP2021/063827

§ 371 Date: Nov. 23, 2022

(30) Foreign Application Priority Data
May 25, 2020 (FR) 2005488

(51) Int. Cl. G08G 5/02; G08G 5/00

(52) U.S. Cl. CPC G08G 5/025; G08G 5/0047; G08G 5/0039

(57) ABSTRACT

An approach assistance method includes: an initial calculation step for calculating a reference path and the application of a stabilization test for determining whether the reference path makes the landing possible; modification steps implemented in a sequence and applying predefined modification rules and applying the stabilization test after each modification; and a transmitting step including transmitting the reference path to the human pilot, to an autopilot and/or to a traffic management system as soon as the reference path passes the stabilization test.

### CROSS-REFERENCE TO RELATED APPLICATION(S)

This application is the U.S. national phase of International Application No. PCT/EP2021/063827 filed May 25, 2021, which designated the U.S. and claims priority to FR 2005488 filed May 25, 2020, the entire contents of each of which are hereby incorporated by reference.

### TECHNICAL FIELD

The present invention relates to the field of assisting with the approach of an aircraft, in particular a transport aircraft, so as to land the aircraft on a landing zone such as an airport runway or on any other terrain or area allowing the aircraft to touch down.

### BACKGROUND

During a descent and/or approach phase prior to landing, an aircraft has to reduce the total energy thereof which is the sum of the potential energy (as a function of the aircraft altitude) thereof and of the kinetic energy (as a function of the aircraft speed) thereof, while establishing a landing configuration suitable for landing of the aircraft (extension of the high-lift devices, deploying the landing gear, etc.)

When preparing for the flight, the crew determines a flight plan, which comprises e.g. a departure point, an arrival point, an arrival procedure, waypoints, i.e. points which have to be crossed vertically by an aircraft must pass during the flight thereof, and/or path segments.

The flight plan is recorded in an electronic system which is configured for enabling the aircraft to follow the flight plan, and in particular for calculating a path following the flight plan, taking into account constraints, including e.g. the aerodynamic performance of the aircraft, weather conditions and flyover rules for overflown areas (air corridors, no flyover areas).

The electronic system is, e.g., a flight management system (FMS) which is an on-board computer, present in particular in aircraft such as transport aircraft.

In preparation for the descent and/or approach phase, i.e. the phase between the cruising phase and the landing, the flight management system periodically calculates a path known as the “approach path”, intended for being followed by the aircraft in order to perform the descent and/or the approach thereof and to land.

The approach path comprises a lateral path which corresponds to all the points which have to be crossed vertically by an aircraft, and a vertical profile (also called a “vertical path”), which defines, in particular, the altitude and the expected speed of the aircraft at each point of the lateral path, as well as aircraft setup points for landing and, if appropriate, segments with airbrakes on which airbrakes are activated for slowing down the aircraft.

The approach path has to reach an approach axis at the latest starting from a Final Approach Fix (FAF) located on the approach axis from which the aircraft begins the final approach thereof towards the runway, and which has to allow the aircraft to be “stabilized” at a stabilization altitude.

“Stabilized” means that the aircraft is in landing configuration and within a predetermined speed range which ensures landing, with a vertical speed and thrust level suitable for a possible go-around, if needed. If the aircraft is not stabilized at the stabilization altitude, the landing is aborted, the pilot having to “go-around”. Landing abortion is expensive, in particular in terms of fuel and time.

The stabilization altitude depends on the landing zone and/or recommendations issued by the airline company operating the aircraft, and followed by the pilot.

The position and altitude of the final approach fix generally depend on the landing zone. Generally, the altitude of the final approach fix is higher than the stabilization altitude. Thus, generally, the stabilization point (the point at which the stabilization altitude is reached) is located between the final approach fix and the landing zone.

The descent and/or approach phase take place under the supervision of air traffic control. Such phase can take place in managed mode, i.e. following the initial flight plan, or in selected mode, i.e. following air traffic control instructions. The selected mode can be necessary e.g. due to the presence of other aircraft, so as to respond to traffic distancing issues.

However, for various reasons (air traffic control instruction, weather conditions, poor modeling of aircraft performance, late action by the aircraft pilot, etc.), the aircraft can end up outside the approach path, and in particular, outside the vertical profile of the approach path planned from the initial flight plan.

The above can force the aircraft crew to search for a new modified approach path which would meet the constraints encountered, while allowing the aircraft to be stabilized in the landing configuration.

The above situation represents additional workload and stress for the crew, in a phase of the flight which already requires special attention from the crew, given in particular, the maneuvers to be done for landing, the relatively low altitude, and generally the heavy air traffic around airports.

### SUMMARY OF THE INVENTION

One of the goals of the invention is to propose a method for assisting in the approach of an aircraft in view of the landing thereof, facilitating the management of the descent and/or approach phase of the aircraft, in particular when it becomes necessary to determine a new approach path.

To this end, the invention proposes a method for assisting in the approach of an aircraft in view of the landing thereof on a landing zone, the method being implemented by computer, the method comprising:
an initial calculation step for calculating a reference path linking the current position of the aircraft to the landing zone, the reference path including a lateral path and a vertical profile, the vertical profile comprising an altitude profile, a speed profile, configuration setup points, a deployment point of the landing gear, and, if appropriate, one or a plurality of segments with airbrakes, and the application of a stabilization test to the reference path so as to determine whether the reference path can be used for the landing;
modification steps implemented successively according to a sequence of modifications, each modification step comprising the calculation of a modification of the reference path according to predefined modification rules specific to the modification step, and the application of the stabilization test to the modified reference path;
a transmission step comprising transmitting of the reference path to the human pilot(s), to an autopilot and/or to a traffic management system, in particular a ground traffic management system, the transmission step being implemented as soon as the reference path calculated in the initial calculation step or modified after one or a plurality of modification steps, passes the stabilization test.

According to particular embodiments, the method for assisting in the approach comprises one or a plurality of the following optional features, taken individually or in all technically possible combinations:
the method comprises the iterative repetition of at least one of the modification steps before going to the next modification step, so as to modify the path by applying several times the modification rules specific to said modification step repeated several times, the repetition being stopped according to a stop criterion specific to the modification step, repeated several times;
the method comprises at least one step of modification by angular adjustment of the lateral path comprising a modification of the lateral path, and a calculation of a new vertical profile according to the modified lateral path;
the method comprises at least one step of modification by adjustment of the vertical profile, each step of modification by adjustment of the vertical profile comprising a modification of the vertical profile, and an adaptation, if appropriate, of the lateral path, which would be carried out for taking into account the modification of the vertical profile;
the method comprises at least one step of modification by adjustment of the vertical profile, wherein the modification is carried out by modifying the speed profile;
the method comprises at least one step of modification by adjustment of the vertical profile, wherein the modification is carried out by modifying the configuration positions of the hyper-lift devices;
the method comprises at least one modification step by adjusting the vertical profile, wherein the modification is carried out by adding segments with airbrakes;
the method comprises at least one step of modification by adjustment of the vertical profile, wherein the modification is carried out by modifying the deployment position of the landing gear;
the method comprises a step of modification by trombone-shape adjustment of the lateral path;
the sequence of modifications comprises sequentially:
   a step of modification, by angular adjustment, of the lateral path comprising the modification of the lateral path, and the calculation of a vertical profile according to the modified lateral path; then
   a sequence of steps of modification by adjustment of the vertical profile comprising at least one step of modification by adjustment of the vertical profile, each step of modification by adjustment of the vertical profile, comprising a modification of the vertical profile and an adaptation, if appropriate, of the lateral path which would take into account the modification of the vertical profile;
wherein said sequence of steps of modification by adjustment of the vertical profile comprises:
   a step of modification by adjustment of the vertical profile, wherein the modification is performed by modifying the speed profile;
   a step of modification by adjustment of the vertical profile, wherein the modification is made by modifying the configuration setup positions of the high-lift devices;
   a modification step by adjusting the vertical profile, wherein the modification is made by adding segments with airbrakes;
   a modification step by adjusting the vertical profile, wherein the modification is made by modifying the deployment point of the landing gear;
the steps of modification by adjusting the vertical profile of the sequence of steps of modification by adjusting the vertical profile, are carried out in the order indicated hereinabove;
the method includes a step of modification by trombone-shape adjustment of the lateral path, implemented after the step(s) of modification by adjustment of the vertical profile;
the stabilization test comprises the calculation of a distance required for landing, and the comparison of the distance required with the length of the reference path, the reference path being validated if the length thereof is greater than the required distance;
the stabilization test comprises the verification of one or a plurality of the following validation conditions, each validation condition being applied to the point of the reference path at which the aircraft must be at the stabilization altitude:
   the predicted speed is less than the approach speed recommended by the aircraft flight manual, plus a predefined validation speed margin;
   the predicted vertical difference is less than a predefined validation vertical difference;
   the predicted vertical speed is consistent with a reference slope plus a predefined validation vertical speed margin;
   the landing gear is predicted as being deployed;
   the landing configuration is predicted as being spread;
   the thrust is not at idle engine speed at the stabilization altitude plus a validation altitude;
the method for assisting in the approach is implemented periodically and comprises the application of an invalidation test to the last validated and transmitted reference path, and the resumption of the calculation of a reference path if the last transmitted reference path is invalidated by the invalidation test;
each validation condition of the stabilization test is associated with an invalidation condition applying to the same parameter as the validation condition, the validation condition and the invalidation condition being intended for applying a hysteresis to said parameter;
the calculation of a reference path is resumed at the initial calculation step or is resumed starting from the last transmitted reference path and by resuming at the modification step following the step which determined the last transmitted reference path;
the invalidation test comprises comparing the difference between a distance required for landing and the length of the reference path, with a predefined difference threshold, the reference path being invalidated if the difference is greater than the difference threshold;
the invalidation test comprises one or a plurality of the following invalidation conditions, each invalidation condition being applied to the point of the reference path at which the aircraft has to be at the stabilization altitude:
   the predicted speed is greater than the approach speed plus a predefined invalidation speed margin strictly greater than the validation speed margin;
   the predicted vertical difference is greater than a predefined vertical invalidation difference strictly greater than the vertical validation difference;
   the predicted vertical speed is greater than the vertical speed corresponding to the reference slope plus a vertical invalidation speed margin strictly greater than the vertical validation speed margin;
   the landing gear is not predicted as being deployed;
   the landing configuration is not predicted as being spread;
   the thrust is not idling at the stabilization altitude plus an invalidation altitude margin strictly less than the validation altitude margin.

The invention further relates to an electronic system, in particular an aircraft flight management system, configured for implementing an approach assistance method as defined above.

The invention further relates to a computer program product which can be stored in a memory and contains software code instructions for implementing an approach assistance method as defined hereinabove, when executed by a processor.

### BRIEF DESCRIPTION OF THE DRAWINGS

The invention and the advantages of the invention will better understood upon reading the following description, given only as a non-limiting example, and made with reference to the enclosed drawings, wherein:

FIG. 1 is a schematic view of an aircraft comprising a flight management system configured for implementing an approach assistance method;

FIG. 2 is a diagram illustrating the steps of the approach assistance method;

FIG. 3 is a diagram illustrating the calculation of a lateral path in an initial calculation step and the first step of modification of the approach assistance method;

FIG. 4 is a graph illustrating a vertical profile for the aircraft, including an altitude profile and a speed profile;

FIG. 5 is a graph illustrating a modification of an aircraft speed profile so as to include an initial acceleration;

FIGS. 6 to 9 are diagrams illustrating steps of modifying an approach path, carried out successively.

### DETAILED DESCRIPTION OF PREFERRED EMBODIMENTS

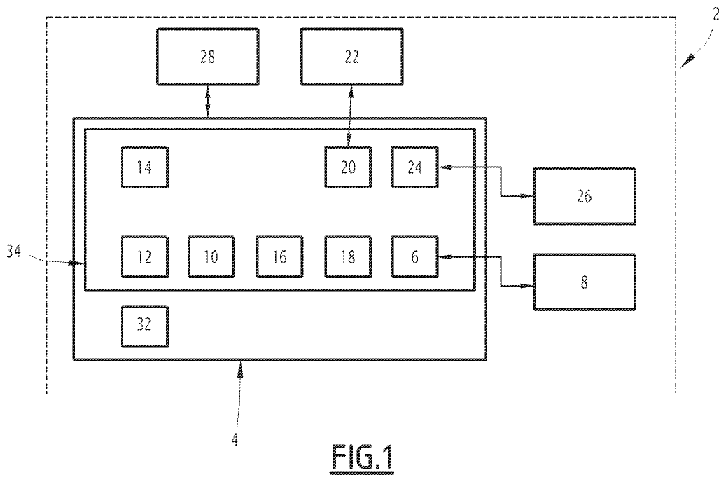

As shown in FIG. 1, an aircraft 2 has an electronic flight management system 4 configured for implementing a method of assisting with the approach of the aircraft 2 for landing on a landing zone.

The landing zone is e.g. an airport runway, or a land or an expanse which allows the aircraft to be landed, without same being an airport runway.

The flight management system (FMS) 4 is a computer which is on-board the aircraft 2 and which is configured for recording a flight plan and for enabling the aircraft 2 to follow the flight plan.

The flight management system 4 comprises a geolocation module 6 configured for determining the geographical location of the aircraft 2 according to the data supplied by one or a plurality of geolocation devices 8. Each geolocation device 8 is e.g. a satellite geolocation receiver, a radio frequency beacon, in particular a very high frequency (VHF) radio frequency beacon or an inertial unit.

The flight management system 4 comprises a flight plan module 10 for storing the flight plan (departure procedure, waypoints, arrival procedure, etc.).

The flight management system 4 comprises a navigation database 12 containing, in particular, data relating to navigation constraints. Such navigation constraints are e.g. altitudes to be observed according to the geographical areas overflown, to the air corridors to be observed according to the geographical areas overflown, etc.

The flight management system 4 comprises a performance database 14 containing data relating to the performance of the aircraft 2. Such data include e.g. the aerodynamic parameters of the aircraft 2 and the engine parameters of the aircraft 2. Such data can be used for determining the possibilities the aircraft 2 has for following a determined path.

The flight management system 4 comprises a lateral path module 16 configured for calculating a continuous lateral path from the constraints defined in the flight plan, in particular adhering to the performance of the aircraft 2 and the navigation constraints.

The flight management system 4 comprises a prediction module 18 configured for building a vertical profile from the lateral path determined by the lateral path module. The vertical profile contains an altitude profile defining the altitude of the aircraft 2 at each point of the lateral path, a speed profile defining the speed of the aircraft 2 at each point of the lateral path, if appropriate, a deceleration beginning point corresponding to the beginning of deceleration towards the approach speed, configuration setup points, each configuration setup point corresponding to a maneuver of the high-lift devices of the aircraft 2, a landing gear deployment point, and, if appropriate, one or a plurality of segments with airbrakes, each segment with airbrakes being a segment of the path on which the airbrakes are activated for increasing the aerodynamic drag of the 2 aircraft.

The aircraft high-lift devices 2 are extensible devices for increasing the lift when spread. The high-lift devices are e.g. retracted during cruising flight. Same usually comprise flaps and slats.

The flight management system 4 comprises a guiding module 20 configured for guiding the aircraft 2 along the path defined by the lateral path and the vertical profile. The guiding module 20 is e.g. in communication with an autopilot 22 of the aircraft.

The flight management system 4 comprises a communication module 24 configured for communicating with the air traffic control 26 and other aircraft.

The flight management system 4 is in communication with a human-machine interface device 28 which can be used by the pilot(s). The human-machine interface device 28 comprises at least one display device for images readable by the pilot(s), for displaying images containing information, e.g. a path, a lateral path and/or a vertical profile. The human-machine interface device 28 allows the pilot(s) to enter commands. For this purpose, the image display device is e.g. a touch device.

The flight management system 4 is configured for implementing an approach assistance method for providing assistance to the aircraft pilot by determining an approach path for performing the landing.

The aircraft 2 is initially on a so-called “active” path, which has been selected by the pilot(s) and which is followed by the aircraft 2. The active path is e.g. the path calculated from the initial flight plan. There can be another path, if the pilot(s) have modified the initial flight plan.

The approach assistance method is intended for being implemented periodically when the aircraft 2 approaches the destination thereof, and more particularly when the aircraft 2 is in the descent and/or approach phase or when the aircraft is still in the cruising phase but at a distance from the destination less than an activation distance. The activation distance is e.g. 150 nautical miles (NM).

The purpose of the approach assistance method is to calculate the shortest possible reference approach path (hereinafter referred to as the “reference path”) for landing, and to transmitted said path to the pilot(s) along with the piloting hypotheses used in the calculation. The pilot(s) can thus choose to follow said reference path, follow a longer approach path which could a priori be used for the landing, or further use said reference path for discussing with the air traffic control if the latter proposes a longer approach path, and hence more expensive in terms of time and fuel.

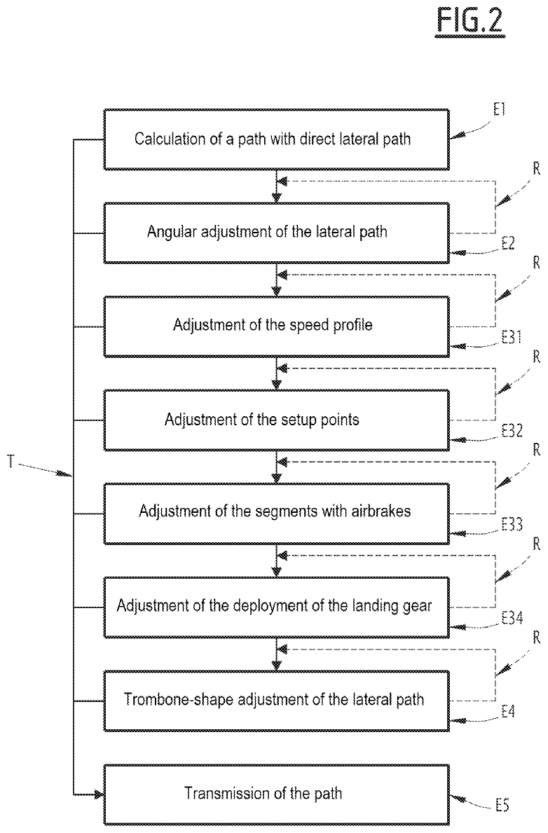

As shown in FIG. 2, the approach assistance method comprises:
an initial calculation step E1 comprising the calculation of a reference path linking the current position of the aircraft to the landing zone, the reference path including a lateral path and a vertical profile, the vertical profile comprising an altitude profile defining the altitude of the aircraft 2 at each point of the lateral path, a speed profile defining the speed of the aircraft 2 at each point of the lateral path, if appropriate, a deceleration beginning point corresponding to the beginning of the deceleration towards the approach speed, configuration setup points, each configuration setup point corresponding to a configuration setup maneuver of the high-lift devices, a landing gear deployment point, and, if appropriate, one or a plurality of segment(s) with airbrakes, each segment with airbrakes being a path segment on which the airbrakes are activated, and the application of a stabilization test to the reference path so as to determine whether the reference path can be used for the landing;
Successive modification steps E2, E31, E32, E33, E34, E4, implemented according to a sequence of modifications, each modification step E2, E31, E32, E33, E34, E4 comprising the modification of the reference path according to predefined modification rules specific to the modification step, and the application of the stabilization test to the modified reference path; and
a transmission step E5 comprising transmitting the reference path to the pilot and/or to an air traffic management system, the transmission step being implemented as soon as the reference path calculated during the initial calculation step or modified after one or a plurality of modification steps, passes the stabilization test, the sequence of modifications being interrupted, as illustrated by the arrow T.

Each modification step E2, E31, E32, E33, E34, E4 is implemented after the initial calculation step E1 if the reference path calculated during the initial calculation step E1 does not pass the stabilization test or after the previous modification step if the reference path calculated in the previous modification step does not pass the stabilization test.

Transmitting the reference path comprises e.g. transmitting the reference path to an image display device which can be consulted by a human pilot for the display of the reference path by the image display device, transmitting the reference path to an autopilot, and/or to an air traffic management system, in particular a ground air traffic management system.

The approach assistance method can comprise, if appropriate, an iterative repetition of at least one of the modification steps E2, E31, E32, E33, E34, E4 before going to the next modification step, as illustrated by the arrows R, so as to modify the reference path by applying several times, the modification rules specific to said modification step repeated several times, the repetition being stopped according to a stop criterion specific to each modification step repeated several times.

Examples of implementation of iterative repetitions of modification steps will be described thereafter.

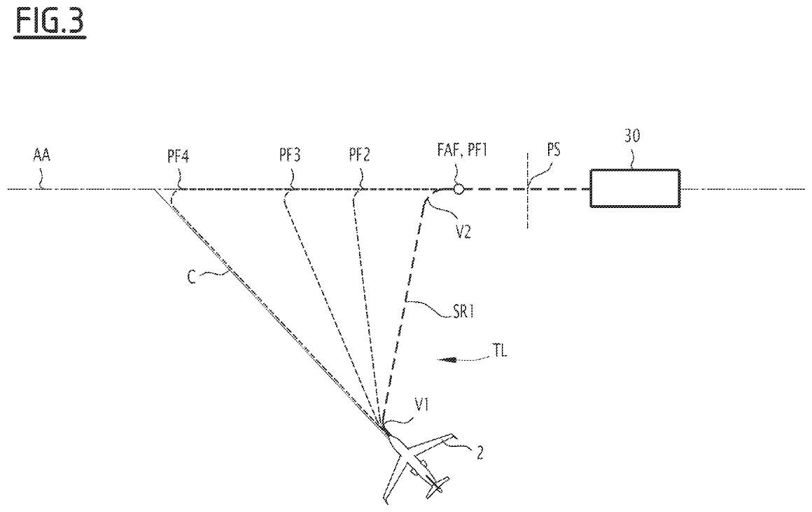

As shown in FIG. 3, the aircraft 2 should land on a landing zone 30 by aligning in the final approach phase with an approach axis AA at the latest at a final approach fix FAF located on the approach axis AA.

The aircraft 2 should reach a stabilization point PS, located at stabilization altitude as (e.g. 1000 feet) at an approach speed VAPP. The stabilization point PS is generally located along the approach axis AA, between the final approach fix FAF and the landing zone 30.

Meeting such criteria should allow the aircraft 2 to land safely, having still the possibility of canceling the landing procedure and to go-around if there is a problem.

The initial calculation step E1 comprises the calculation of a lateral path TL connecting the current position of the aircraft 2 to the landing zone 30 by determining a lateral path TL as direct as possible, taking into account as the only constraint, the operational constraint to align with the approach axis AA at the final approach fix FAF and the calculation of a vertical profile observing as the only constraint, the altitude and/or speed constraint at the final approach fix FAF, if there is such altitude and/or speed constraint.

The lateral path TL is calculated e.g. by the lateral path module 16, according to the flight plan recorded in the flight plan module 10, to the data from the navigation database 12 and to the data from the performance database 14.

In one embodiment, the lateral path TL is determined by connecting the current position of the aircraft 2 to the landing zone 30 using the following successive lateral path elements:
a first turn V1 for bringing the heading of the aircraft 2 closer to the final approach fix FAF, the first turn V1 connecting the current position of the aircraft 2 to a first turn V1 end point,
a first rectilinear segment SR1 connecting the end point of first turn V1 to a second turn V2 start point,
a second turn V2 for aligning the aircraft heading with the approach axis AA, the second turn V2 connecting the second turn V2 start point to a second turn end point located on the approach axis AA, the heading of the aircraft 2 being aligned with the approach axis AA, and
a second rectilinear segment SR2 connecting the second turn V2 end point to the landing zone 30.

The second turn V2 end point is the final approach fix FAF. At the end of the first turn V1 and along the first rectilinear segment SR1, the heading of the aircraft 2 does not cross the approach axis AA at the final approach fix FAF but slightly upstream along the approach axis AA, so that the second turn V2 can be made before the final approach fix FAF, depending on the predicted speed of the aircraft 2.

Each turn of the lateral path TL (i.e. the first turn V1 and the second turn V2) can consist of only one circular arc or broken down into a plurality of arcs of a circle, having, if appropriate, different radii so as to best adapt to variations in speed and altitude of the aircraft 2 modifying the roll capacity.

The initial calculation step E1 comprises the calculation of a vertical profile PV corresponding to the lateral path TL.

The vertical profile PV is calculated e.g. by the prediction module 18 of the flight management system 4, according to the lateral path TL, of the flight plan recorded in the flight plan module 10, to the data from the navigation database 12 and to the data from the performance database 14.

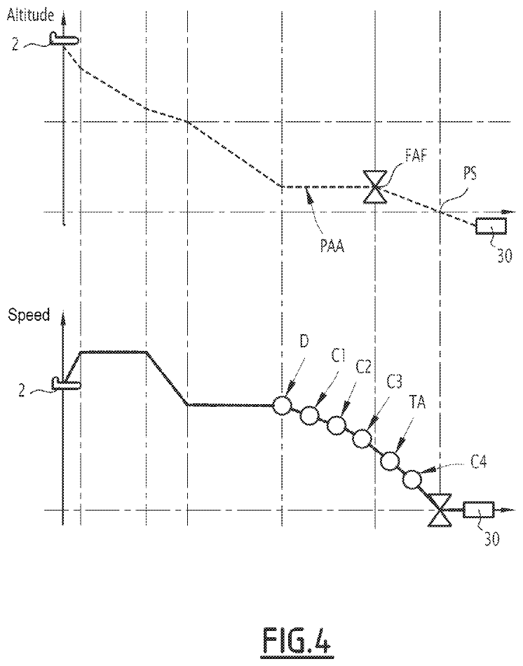

FIG. 4 shows a vertical profile PV in the form of a first graph representing a PALT altitude profile and a second graph representing a PSPD speed profile.

In one embodiment, the vertical profile PV calculated during the initial calculation step E1 includes a PALT altitude profile comprising one or a plurality of the following elements:
a plateau at the current altitude of the aircraft 2 if the total distance between the current point of the aircraft 2 and the stabilization point PS is greater than the distance required for being stabilized;
a descent at the idle engine speed from the current altitude of the aircraft 2 to an approach altitude corresponding e.g. to an altitude constraint at the final approach fix FAF, if there is such altitude constraint, or to a default approach altitude, e.g. an altitude of 1,500 feet. The beginning of the descent at idle engine speed can comprise an acceleration towards a speed which makes possible a better rate of descent, which is a more efficient energy dissipation strategy. The descent to idle engine speed can comprise a deceleration of the aircraft so as to observe speed constraints, if appropriate, such as e.g. descent speed limits;
a plateau at the approach altitude PAA. Such plateau at the approach altitude allows the aircraft 2 to decelerate from the descent speed to a lower speed;
a constant slope descent from the final approach fix FAF to the destination (this is the “final” approach), based on a final approach slope specified in the selected arrival procedure, or on a default final approach slope, which can be equal e.g. to −3°. The approach descent optionally includes deceleration segments, during which the speed of the aircraft 2 is slowed down to the approach speed.

The vertical profile PV further defines configuration setup points C1, C2, C3, C4, a deployment point of the landing gear TA, and, if appropriate, a point of beginning of deceleration D. Such points can be represented along the vertical profile PV (in particular on the speed profile PSPD) or along the corresponding lateral path TL, as will be done thereafter.

The aircraft 2 comprises, if appropriate, a plurality of possible landing configurations. A predefined sequence of configuration setups can be used for achieving the landing configuration chosen by the pilot.

The initial calculation step E1 comprises the application of the stabilization test to the reference path calculated during the initial calculation step E1.

The stabilization test determines whether the reference path stabilizes the aircraft 2 at the stabilization altitude required at the stabilization point PS shown in FIG. 3.

The same stabilization test is implemented at the end of the initial calculation step E1 and at the end of each iteration of the modification steps E2, E31, E32, E33, E34, E4 of the reference path.

In one example of embodiment, the stabilization test comprises the calculation of a distance required for landing, and the comparison between the distance required for landing and the length of the reference path.

The distance required for landing is a minimum length required for a sufficient reduction in the total energy of the aircraft 2 so as to make landing possible, plus, if appropriate, a distance margin.

The total energy of aircraft 2 is the sum of the potential energy thereof, which depends on the altitude of the aircraft 2, and of the kinetic energy thereof, which depends on the speed of the aircraft 2.

The distance required for landing is calculated e.g. in a known manner by the flight management system 4, taking into account the performance of the aircraft 2 and the flight conditions (weather conditions, etc.).

According to one example of implementation, the stabilization test is validated or positive (i.e. the reference path considered is “stable” or “valid”) if the length of the path is greater than the required distance. If the required distance includes a distance margin, the margin is relatively small, the purpose being to propose a reference path as short as possible. The possible distance margin is e.g. less than 5 nautical miles, and in particular comprised between 1 nautical mile and 2 nautical miles.

The stabilization test using the distance required for landing can be used for a simple and fast calculation and uses a functionality already known from the flight management systems of transport aircraft, namely the calculation of the distance required for landing.

In another example of embodiment, the stabilization test comprised the verification of one or a plurality of validation conditions, each validation condition comparing the predicted value of a parameter of the aircraft 2 (the value of said parameter in the predicted vertical profile) with a reference value.

The stabilization test comprises e.g. the verification of one or a plurality of the following validation conditions, each validation condition being applied to the point of the path at which the aircraft 2 is at the stabilization altitude AS:
the predicted speed is less than the approach speed recommended by the aircraft flight manual, plus a predefined speed margin (e.g. 5 knots);
the predicted vertical difference is less than a reference vertical difference (e.g. 10 feet);
the predicted vertical speed is consistent with a reference slope plus a predefined vertical speed margin (e.g. 10 feet/minute);
the landing gear is predicted as being deployed;
the landing configuration is predicted as being spread; and/or
the thrust is not at idle engine speed at the stabilization altitude plus an altitude margin (e.g. 100 feet).

In general, if the reference path is validated (positive stabilization test), the approach assistance method goes to transmitting step E5.

If the reference path is not validated, the approach assist method goes to the next modification step or, where appropriate, to the next iteration of the current modification step.

In the case of the initial calculation step E1, if the reference path calculated during the initial calculation step E1 is not validated by the stabilization test, the approach assistance method goes to the first modification step E2 of the modification sequence.

As illustrated in FIG. 2, the sequence of modifications comprises e.g. a first modification step E2 which is a modification step by angular adjustment of the lateral path TL (hereinafter “step of angular adjustment of the lateral path”), comprising a modification of the reference path by modifying the lateral path TL and then again calculating a corresponding vertical profile PV.

In an example of implementation, the lateral path TL is modified by modifying the angle of the first turn V1 so as to move the end point of the second turn V2 along the approach axis AA upstream of the final approach fix FAF.

The step of angular adjustment of the lateral path E2 comprised the application of the stabilization test to the modified reference path.

If the stabilization test is positive, the approach assistance method goes to transmission step E5.

If the stabilization test is negative, in an example of implementation, the approach assistance method comprises the iterative repetition of the step of angular adjustment of the lateral path E2 until the reference path passes the stabilization test or a stop criterion is reached. If the modified reference path does not meet the stabilization test but the stop criterion is met, the approach assistance method goes to the next modification step.

During the iterative repetition of the step of angular adjustment of the lateral path E2, the angle of the first turn is modified at each iteration so as to progressively move the end point of the second turn V2 back along the approach axis AA.

In one example of embodiment, the angle of the first turn V1 is modified by a constant pitch between the iterations (e.g. a pitch of 10°), with a last pitch less than the constant pitch, adjusted so that the last iteration is performed with the setpoint heading of the aircraft 2, i.e. with a first zero angle turn if the aircraft is stabilized on the lateral setpoint thereof, which is consistent with the path followed by the aircraft.

FIG. 3 illustrates reference trajectories calculated successively by angular adjustment, with second turn end points PF1, PF2, PF3, PF4 progressively moving back along the approach axis AA, as far as to the lateral path TL calculated with the setpoint heading of the aircraft 2, reaching the approach axis at the second turn end point PF4.

In another example of implementation, the lateral path is modified by calculating a first turn angle V1, defining a point of intersection of the aircraft heading 2 at the end of the first turn with the approach axis AA, so that the sum of the distance between the current position of the aircraft 2 and the point of intersection and the distance between the point of intersection and the runway 30 is equal to the distance required for landing.

Although the lateral path TL calculated in this way takes into account the required distance, the stabilization test, taking into account the lateral path TL and also the vertical profile PV and the flight conditions, is not necessarily positive.

In one mode of implementation, the sequence of modifications then comprises at least one modification step by adjusting the vertical profile E31, E32, E33, E34.

In each step of adjusting the vertical profile E31, E32, E33, E34, the vertical profile PV is modified according to predefined vertical profile PV modification rules, adapting, if appropriate, the lateral path (TL) so as to take into account the modification of the vertical profile PV.

The modification of the vertical profile PV can entail a modification of the speed profile PSPD of the aircraft 2 making it difficult to produce the previously calculated lateral path TL. For the above reason, it may be necessary to adapt the lateral path TL according to the modification of the vertical profile PV. Such an adaptation is nevertheless minor.

In an example of implementation, the sequence of modifications comprises a sub-sequence of a plurality of modification steps by adjusting the vertical profile E31, E32, E33, E34.

In one example of embodiment, the sub-sequence of vertical profile adjustment modification steps sequentially comprises:
a step of modification by adjusting the vertical profile E31 wherein the modification is carried out only by modifying the speed profile (hereinafter referred to as the “step of adjusting the speed profile”);
a step of modification by adjusting the vertical profile E32 wherein the modification is carried out by modifying the configuration setup positions (hereinafter referred to as the “step of adjusting the configuration setup positions”);
a step of modification by adjusting the vertical profile E33 wherein the modification is carried out only by modifying the segments with airbrakes (hereinafter “step of adjusting the segments with airbrakes”); then
a step of modification by adjusting the vertical profile E34 wherein the modification is carried out only by modifying the landing gear deployment position (hereinafter referred to as the “step of adjusting the deployment of the landing gear”).

The order of the modification steps within the sub-sequence presented hereinabove is preferred, but all the modification steps of said sub-sequence can be interchanged depending on the performance of the aircraft 2 and the environmental conditions of the flight, so as to always apply the sub-sequence which would be the most effective operationally, making it possible to achieve the best compromise in terms of flight time, fuel consumption, passenger comfort, and maintenance operations.

In each of the steps of modification of the vertical profile E31, E32, E33, E34, the calculation can be performed backwards, i.e. from the landing zone 30 to the aircraft 2, or forward, i.e. from the aircraft to the landing zone. A forward calculation carries the difficulty of knowing the point of beginning of descent so as to reach the final approach fix FAF and the landing zone 30, which is immediate with a backward calculation. Conversely, a backward calculation cannot be used for directly calculating an acceleration segment at the beginning of the path, but nevertheless can be used for calculating iteratively.

In one example of embodiment, the step of adjusting the speed profile E31 comprises the modification of the speed profile by providing the acceleration of the aircraft 2 (increase in speed) over a segment of the reference path, in particular on an initial segment of the reference path starting from the current position of the aircraft 2.

Paradoxically, although accelerating leads to an increase in total energy due to the resulting increase in kinetic energy, a higher speed enables a higher gradient of descent to be achieved, which ultimately leads to a better dissipation of the total energy. Indeed, increasing the kinetic energy makes it possible to descend faster and dissipate the kinetic energy again at lower altitude, in a denser mass of air. Overall, it is therefore more efficient to start by accelerating when the aircraft 2 is too high and has a speed margin compared to the maximum operational speed.

The PSPD speed profile shown in FIG. 4 shows an initial acceleration phase.

When the 2 aircraft is in the selected speed mode (i.e. e.g. when the aircraft follows an air traffic control constraint, e.g. because the aircraft is integrated into an aircraft stream with no high margin in speed maneuverability), the aircraft 2 is accelerated e.g. until achieving one of the following:
the altitude of the deceleration plateau;
the current aircraft speed plus a predefined speed variation (e.g. 10 knots under calibrated air speed (CAS)) or the equivalent in MACH.

When the aircraft is in a managed speed mode (i.e. when following a speed defined by the flight management system, free from any air traffic control constraints), the aircraft 2 is accelerated e.g. until achieving one of the following:
the altitude of the deceleration plateau;
the minimum between:
   the value of the last applicable sequenced constraint in the flight plan of type “at” or “at or below” plus a predefined speed variation (e.g. 10 knots);
   the maximum permissible speed value (“speed limit”) applicable according to the navigation data, plus a predetermined speed variation (e.g. 10 knots) when the aircraft is below the maximum authorized speed altitude (the maximum authorized speed below 10,000 feet is generally 250 knots);
   the maximum operational speed of the aircraft 2.

The maximum operational speed is equal to VMAX−ΔVMAX, where VMAX is the maximum speed of the aircraft 2 in the current aerodynamic configuration, and ΔVMAX is a safety margin.

In the event that the calculation is performed backwards, the acceleration will take place until reaching the speed defined hereinabove, limited by the maximum speed that the aircraft 2 can reach.

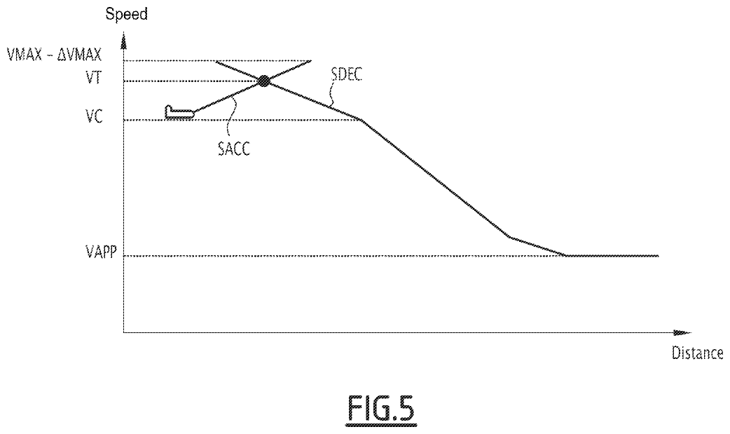

Thus, seen from the aircraft 2, as illustrated in FIG. 5, the target maximum speed VT expected at the end of the initial acceleration, is the speed corresponding to the intersection of an acceleration segment SACC of the current speed of the aircraft up to the maximum operational speed VMAX−ΔVMAX and a deceleration segment SDEC of the maximum operational speed VMAX−ΔVMAX up to one end of a speed plateau at the current speed of the aircraft 2.

In one example of embodiment, the step of adjusting the speed profile E31 is repeated iteratively, by increasing the acceleration or the length of the segment on which the acceleration is performed at each iteration, until a stop criterion is reached, which is e.g. reaching the intersection.

At each iteration, the stabilization test is carried out so that if the reference path is valid, the approach assistance method goes to the transmitting step E5, without carrying out the next iteration.

In a variant, the acceleration is calculated by an estimator configured for determining the acceleration capability of the aircraft 2.

In any case, the goal is not to create discontinuities along the PSPD speed profile.

The step of adjusting configuration setup points E32 comprises moving at least one of the configuration setup points C1, C2, C3, C4 so that the configuration setup is performed earlier, hence for a higher speed of the aircraft 2, without, however, exceeding the maximum speed authorized for such a configuration setup C1, C2, C3, C4.

Generally, and in particular in FMS flight management systems, the path is calculated by default using the associated minimum speed for each configuration setup.

To dissipate more energy, it is possible to modify the reference path by initiating at least one of the configuration setups earlier.

The possible adjustment range for each configuration setup is between the minimum speed associated with said configuration setup and the maximum speed of maneuver and use of the high-lift devices, which is called VFE.

Preferentially, according to the approach assistance method, the adjustment of the configuration setup points C1, C2, C3, C4 is carried out without exceeding a maximum safe speed corresponding to the maximum speed of maneuver and use of the high-lift devices (VFE) minus a safety margin (e.g. 5 knots).

The above protects against a possible gust of wind and adverse effects on the structure.

The step of adjusting the configuration setup points E32 e.g. is repeated iteratively, changing the position of only one of the configuration setup points C1, C2, C3, C4 at each iteration, so that the configuration setup points C1, C2, C3, C4 are moved one-by-one, following a sequence.

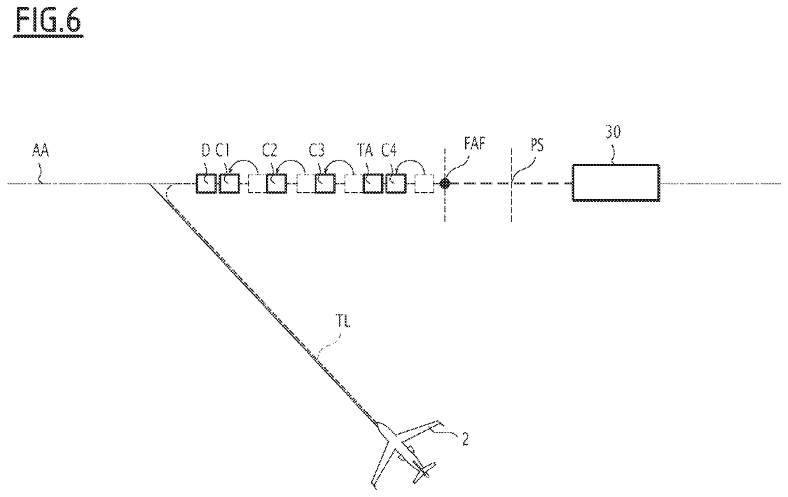

FIG. 6 illustrates an adjustment of the configuration setup points C1, C2, C3, C4.

In an example of embodiment, the adjustment of the configuration setup points C1, C2, C3, C4 is done starting with the last configuration setup point C4 and going back to the first configuration setup point C1.

In another example of embodiment, the adjustment of the configuration points C1, C2, C3, C4 is done e.g. by an estimator executed by a computer, the estimator being configured for determining the optimum speed for each configuration setup point C1, C2, C3, C4 so as to maximize the reduction of the total energy.

In the example shown, it has been assumed that the aircraft 2 has four configurations C1, C2, C3, C4 for the high-lift devices, as is the case for a large majority of the current transport aircraft. Of course, the aircraft 2 could have a maximum number of configurations less than four or greater than four. In particular, the aircraft could have only one configuration, two configurations, three configurations, or more than four configurations. The step of adjusting the configuration setup points E32 would apply similarly.

During the descent and/or approach phase, the airbrakes are used for slowing down the aircraft 2. Airbrakes are used per path segment, a path segment on which the airbrakes are activated being a segment with airbrakes.

The step of adjusting the airbrakes E33 comprises the addition of at least one segment with airbrakes, in particular only one segment with airbrakes.

In an example of embodiment, the step of adjusting the airbrakes E33 is repeated iteratively, so that the number of segments with airbrakes increases as the iterations progress. At each iteration, a segment with airbrakes is added.

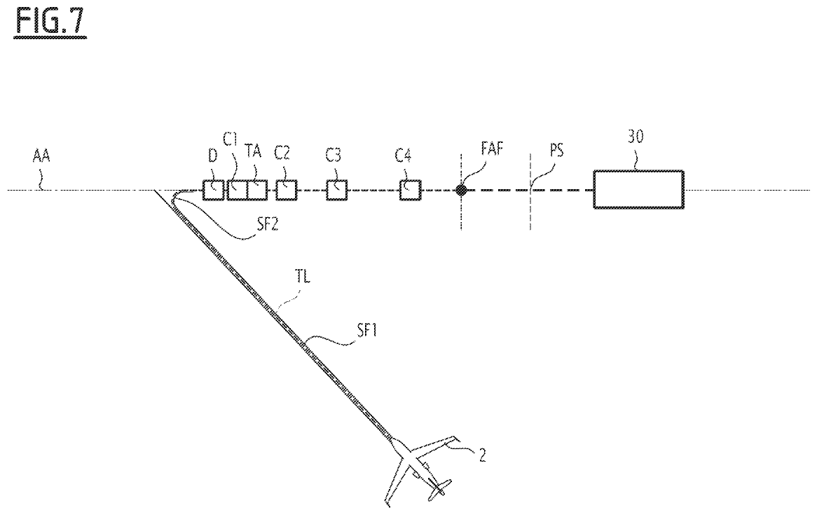

FIG. 7 illustrates the progressive adjustment of the use of airbrakes, path segment by path segment, from the aircraft to the runway, the added segments with airbrakes SF1, SF2 being represented by a continuous line along the lateral path TL represented by dotted lines.

In an example of embodiment, the iterative adjustment of the segments with airbrakes is performed path segment by path segment, starting from the aircraft 2 and progressing towards the runway 30. Such solution is preferred because same is more operational and makes it possible to subsequently keep a margin during the flight.

In FIG. 7, a first segment with airbrakes SF1 and a second segment with airbrakes SF2 were added successively, during respective iterations of the step of adjusting the airbrakes E33.

In one example of embodiment, the iterative adjustment of the use of airbrakes is performed path segment by path segment, starting from the stabilization point PS and progressing towards the aircraft 2. Such solution is generally more efficient in terms of energy dissipation, the efficiency of airbrakes increasing with the air density.

In an example of embodiment, the path segments considered for the activation of the airbrakes are, e.g., the path segments resulting from the calculation of the path (rectilinear segment, curved segment, segment between two control points, etc.).

In an example of embodiment, the path segments considered are path segments obtained by dividing the path into path segments with a predefined length (e.g. 5 nautical miles). In an example of embodiment, the predefined length is chosen e.g. depending on the distance or per range of altitude depending on the fineness of the desired result.

The airbrakes are used e.g. with a maximum percentage of use along the path. The maximum use percentage is e.g. 50% of the path length (the current maximum value on certain aircraft so as to keep the autopilot engaged) and could be 100% in the case of fully autonomous aircraft with new capabilities. Of course, the prediction of the use of airbrakes takes into account all the operational restrictions conventionally used (and sometimes specific to the type of aircraft) such as e.g. (non-exhaustive list):
the non-compatibility with a configuration of the high-lift devices;
a noise constraint, preventing e.g. the use on the final approach slope;
a computer failure;
an actuator failure which can cause a partial inhibition of the airbrakes for structural and maneuverability reasons, and prevent asymmetries;
a protection of the lead angle;
a position of the throttle lever;
a priority given to roll in case of conflict; and/or
a rate of extension which is dependent on the speed for structural reasons. etc.

The step of deploying the landing gear E34 comprises e.g. the modification of the path by anticipating the deployment of the landing gear, i.e. moving up the point of deployment of the landing gear TA along the path.

An early extension of the landing gear is an effective way to absorb excess energy.

In a transport aircraft having four configurations of the high-lift devices, the point of deployment of the landing gears TA is e.g. provided between the third configuration setup point C3 and the fourth configuration setup point C4, which is a conservative solution.

The possible range of variation for anticipating the position of deployment of the landing gear thus extends from the current solution to a speed called “VLE−ΔVLE”, VLE representing the maximum extension speed of the landing gear, specific to the aircraft considered, and ΔVLE representing the associated margin for protection against the structural effects of a possible gust. ΔVLE is an adjustable value, which can be set e.g. at 5 knots.

In an example of embodiment, the adjustment of deployment of the landing gear is performed discretely and iteratively. The step of adjusting the deployment of the landing gear E34 is repeated iteratively, moving up the deployment point of the landing gears TA at each iteration, e.g. in constant pitches (e.g., moving the position up to a previous position at which the speed of the 2 aircraft is 10 knots higher) or by dichotomy.

The step of adjusting the deployment of the landing gear E34 is repeated until the reference path is valid, in which case the approach assistance method goes to the transmitting step E5, or a repeat stop criterion is reached, in which case the approach assistance method goes to a next modification step.

In another example of embodiment, the step of adjusting the deployment of the landing gear E34 is implemented by an estimator configured for calculating a new point of deployment of the landing gear TA which decreases the total energy, and preferentially optimizing the decrease of the total energy, taking into account the speed constraints for the deployment of the landing gear.

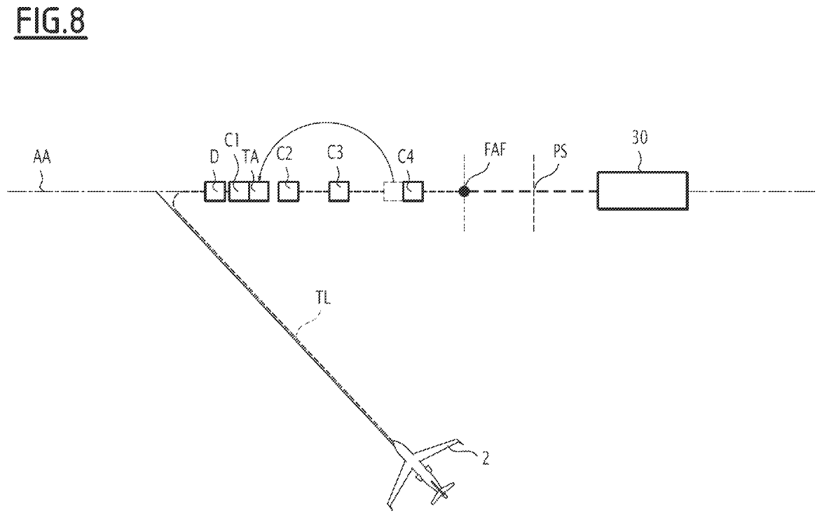

FIG. 8 shows an example of adjustment of the deployment of the landing gear, according to which the point of deployment of the landing gear TA is moved up from the path segment between the configuration setup point C3 in the third configuration and the configuration setup point C4 in the fourth configuration, at the path segment located between the configuration setup point in the first configuration C1 and the configuration setup point in the second configuration C2.

The steps of modifying the vertical profile E31, E32, E33, E34 carried out automatically by calculation can be used for anticipating the result of a later action, in order to prevent an immediate action.

Thus, the use of a computer such as the flight management system makes it possible, e.g. to guarantee that the only optimized use of the downstream high-lift devices makes it possible to not use the upstream airbrakes, nor to anticipate the deployment of the landing gear.

Such anticipation capability generates fuel savings, reduces flight time, and optimizes passenger comfort and maintenance operations through a reduced use of actuators.

The steps of modification by adjusting the vertical profile E31, E32, E33, E34 have been described in a particular order which is considered as preferred. The steps of modification by adjusting the vertical profile E31, E32, E33, E34 can be carried out in a different order so as to adapt to the effectiveness of each of the modifications (speed profile, times of use of the airbrakes, times of aerodynamic configuration setup, time of deployment of the landing gear) depending on the type of aircraft, of the flight conditions or of the usual practices of each airline.

The approach assistance method optionally comprises a step of modification by trombone-shape adjustment E4 of the lateral path (hereinafter “step of trombone-shape adjustment”). The step of trombone-shape adjustment E4 is preferentially the last step in the sequence of modifications.

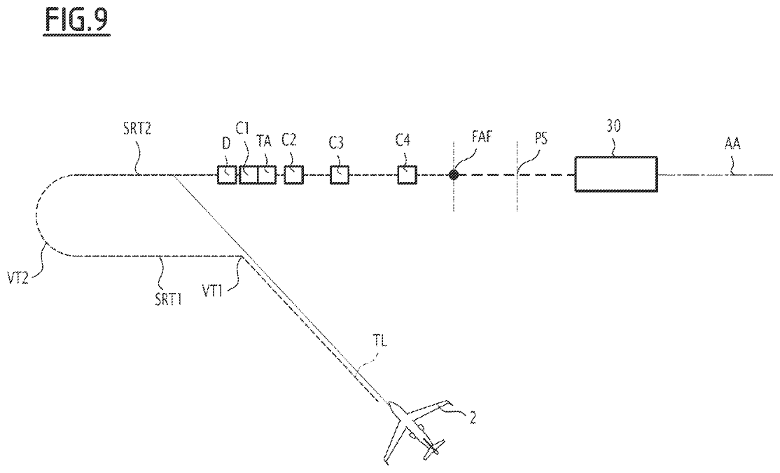

As illustrated in FIG. 9, the trombone-shape adjustment step E4 consists of adjusting the lateral path TL again so as to obtain a “trombone” shape, thus lengthening the lateral path TL previously obtained at the end of the step of adjusting the lateral path.

The term “trombone” shape refers to a general “U” shape, comprising two rectilinear trombone segments SRT1, SRT2 connected by a trombone-shape turn VT2 at substantially 180°. The two rectilinear segments are substantially parallel to each other. The trombone-shape turn VT2 can include only one circular arc or, if appropriate, two quarter circles connected by an intermediate straight segment, if the two rectilinear trombone segments SRT1, SRT2 are very far apart.

The trombone-shape adjustment consists of making the aircraft 2 follow a trombone-shaped path portion, the second rectilinear segment SRT2 of which is aligned with the approach axis AA, so that at the end of said path portion, the aircraft 2 is aligned with the approach axis AA and flies towards landing zone 30.

The trombone-shape adjustment comprises the calculation of an orientation turn VT1 for orienting the heading of the aircraft 2 substantially parallel to the approach axis AA, followed by the trombone shape.

In an example of embodiment, the trombone-shape adjustment is performed by calculating an orientation turn VT1 performed immediately from the current position of the aircraft 2. The above situation can lead to a large VT2 trombone-shape turn. Such solution has the advantage of being more stable and continuous and, hence, easier to implement. Although less operationally realistic, same seems sufficient for allowing the crew to understand the situation.

In another example of embodiment, the trombone-shape adjustment is carried out by calculating an orientation turn VT1 carried out “at the latest”, i.e. making it possible to carry out a trombone-shape turn VT2 having the smallest possible radius.

In order to ensure continuity in the modification of the reference path, and to ensure the stability of the modification function of the reference path, the lateral path obtained at the end of the trombone-shape adjustment step E4 should be longer than same previously obtained.

Otherwise, a preliminary angular adjustment or “a longer trombone” will be used beforehand.

As soon as the reference path calculated at the initial calculation step E1 or at the end of one of the modification steps E2, E31, E32, E33, E34, E4 has been validated by the stabilization test, the transmitting step E5 is implemented.

The transmitting step E5 comprises transmitting the calculated and validated reference path to the pilot(s) and/or to an air traffic management system, in particular a ground air traffic management system.

In the case of one or a plurality of human pilots, the transmitting step E5 comprises the display of the reference path on a display device which can be read by the pilot(s), e.g. on a display device located in the cockpit of the aircraft 2. The display device comprises e.g. a display screen for the lateral path, e.g. a Navigation Display, and a display screen, for the vertical profile e.g. a Vertical Display.

The lateral path and the vertical profile can be displayed on a three-dimensional display device which allows the lateral path and the vertical profile to be viewed simultaneously.

The display device is preferentially configured so that the reference path is displayed by default or at the request of the pilot, and the parameters thereof can be set. In both cases, the reference path should be available for display preferentially when the current flight phase is the descent and/or approach phase, and/or when the aircraft is still in the cruising phase but at a distance from the active destination below a predetermined threshold (e.g. 150 nautical miles) whether the aircraft is in managed lateral mode (flight plan tracking) or selected lateral mode (air traffic control instruction tracking).

The display of the reference path and the display of the active path are performed simultaneously in superposition, with different lines for distinguishing between the paths.

The reference path display preferentially comprises the distinct display of the following elements:
the point of beginning of descent (if there is such a point);
the acceleration segment (if there is such a segment) and the associated target speed;
the deceleration segment (if there is such a segment) towards the limit descent speed
the path segments (if there are such segments) on which air brakes are used;
the plateau setting point corresponding to the beginning of deceleration towards the stabilization speed;
the times of configuration setup; and/or
the time of deployment of the landing gear.

In one example of embodiment, at least one of the aforementioned elements is exclusive of the corresponding element of the active path. The display of the displayed reference path element leads to removing the display of the corresponding element from the active path. In this way it is possible to unclutter the display in order to facilitate the understanding by the crew.

Once the reference path calculated during the initial calculation step E1 or at the end of one of the modification steps E2, E31, E32, E33, E34, E4 has been validated by the stabilization test, an evolution of circumstances (e.g. a pilot action, a modification of weather conditions, etc.) can invalidate the validated reference path.

Preferentially, the approach assistance method is implemented periodically so as to determine whether a new reference path is needed and for recalculating the new reference path.

The approach assistance method implemented periodically comprises the verification of the validity of the current reference path (i.e. the last validated and transmitted reference path).

The verification of the current reference path comprises the application of an invalidation test for verifying whether the current reference path remains valid.

The invalidation test e.g. is applied periodically so as to periodically verify that the current reference path remains valid. The verification period is e.g. comprised between 1 and 20 seconds, in particular between 1 and 5 seconds.

As long as the current reference path remains valid (the invalidation test is negative), the current reference path is used, e.g. by staying displayed on a display device which can be read by the pilot(s).

When the invalidation test is positive (the current reference path is no longer valid), the approach assistance method comprises the resumption of the calculation of a reference path.

In one example of embodiment, the resumption of the calculation of a reference path is carried out by starting again at the initial calculation step E1.

In a variant, the calculation of a reference path is resumed starting from the current reference path and resuming the calculation at the step at the end of which the current reference path has been validated. The calculation step implemented by the approach assistance method is then a new iteration of said calculation step or the next calculation step.

The invalidation test is preferentially different from the stabilization test. In particular, the stabilization test and the invalidation test are designed so that the validation and invalidation of a reference path occurs with a hysteresis effect.

In this way it can be prevented that a validated reference path is invalidated too quickly, which could lead, e.g., to too frequent modifications of the reference path proposed to the pilot(s) or to the air traffic control, and displayed on a display device.

As indicated hereinabove, in one example of embodiment, the stabilization test comprises the comparison between the length of the path and a distance required for landing.

In such case, in an example of embodiment, the invalidation test comprises comparing the difference between the required distance and the length of the reference path, with a difference threshold, the reference path being invalidated if the difference is greater than the difference threshold. The difference threshold is comprised e.g. between 1 and 2 nautical miles.

As indicated hereinabove, in another example of embodiment, the stabilization test comprises the verification of one or a plurality of validation conditions, each validation condition taking into account a parameter and being applied to the point of the path at which the aircraft 2 is at the stabilization altitude AS, i.e. by taking the value of said parameter at the point of the path at which the aircraft 2 is at the stabilization altitude AS.

In such case, the invalidation test preferentially comprises a respective invalidation condition associated with each validation condition, using the same parameter as the associated validation condition, with a different invalidation margin than the validation margin when a validation margin is used, so as to apply hysteresis to said parameter.

In one example of embodiment, the invalidation test comprises, for each validation condition, the associated invalidation condition taken from amongst the following invalidation conditions, each invalidation condition being applied to the point of the path at which the aircraft 2 is at the stabilization altitude AS:
the predicted speed is greater than the approach speed plus a predefined invalidation speed margin (e.g. 10 knots) strictly greater than the validation speed margin;
the predicted vertical difference is greater than a predefined vertical invalidation difference margin (e.g. 100 feet) strictly greater than the vertical validation difference margin;
the predicted vertical speed is greater than the vertical speed corresponding to the reference slope plus a vertical invalidation speed margin (e.g. 100 feet/minute) strictly greater than the vertical validation speed margin;
the landing gear is not predicted as being deployed;
the landing configuration is not predicted as being spread;
the thrust is not idling at the stabilization altitude plus an invalidation altitude margin (e.g. a zero margin) strictly less than the validation altitude margin.

In a particular example of embodiment, the approach assistance method is implemented by an FMS flight management system.

It is possible to use another system with which the crew is equipped, e.g. an electronic flight bag (EFB).

In general, the approach assistance method is implemented by a computer, in particular by an electronic system configured for the implementation of the approach assistance method.

In an example of embodiment, as illustrated in FIG. 1, the electronic system configured for implementing the approach assistance method comprises at least one processor 32 and a memory 34, each module of the electronic system (e.g. flight plan module 10, lateral path module 16, prediction module 18 of a flight management system) being provided in the form of a software application executable by the processor when the method is stored in the memory.

In a variant, at least one of the modules is provided in the form of a programmable logic component (e.g. an FPGA) or a dedicated electronic circuit (or ASIC).

It is possible to provide a computer program product containing software code instructions executable by a computer when same are stored in a memory, and enabling the approach assistance method to be implemented. Such a computer program product makes it possible e.g.

to update an electronic system, in particular a flight management system or an electronic flight bag, so that the electronic system can henceforth implement the approach assistance method.

The electronic system is not necessarily on-board the aircraft. Indeed, the electronic system could be located in a remote piloting station, located e.g. on the ground or in another vehicle such as another aircraft or a ship. The above applies in particular in the case where the aircraft is a remotely piloted drone.

Moreover, the approach assistance method could also be implemented in an aircraft either with pilot on board or without pilot on board, having an autopilot sufficiently autonomous for carrying out the descent and approach phase and landing in an autonomous way, possibly following instructions from air traffic control.

In such case, the transmitting step comprises transmitting the path to the autopilot, without display.

Due to the invention, it is possible to obtain a reference path of minimum length for carrying out a landing, with an explicit presentation of the calculation hypotheses used.

Thus, as long as the aircraft flies a more “conservative” path (meaning “longer” path), the pilot sees very clearly that the stabilization thereof is possible, and naturally deduces an operational margin therefrom. If, on the other hand, the flown path is less “conservative” (meaning “shorter”) than the minimum path, the pilot immediately understands that one or a plurality of actions are required to allow the pilot to dissipate more energy and the pilot can act accordingly.

The approach assistance method calculates an effective strategy for stabilizing the aircraft at the stabilization altitude, so as to facilitate on-board decision making and discussions with air traffic control for landing.

The approach assistance method significantly reduces the workload for the crew. In the event of crew failing, the method allows the system to land the aircraft autonomously and safely.

The approach assistance method can advantageously be coupled to a ground/on-board data exchange system to enable air traffic control to take into account the energy-related situation and the actual performance of the aircraft in the instructions transmitted to the air traffic control. The method can further be coupled to path safety systems such as the TAWS (“Terrain Avoidance Warning System”), the TCAS (“Traffic Collision Avoidance System”) or others so as to warn the crew of a possible conflict with an obstacle (weather, terrain, traffic, closed air sector, etc.). Taking into consideration the environment and external constraints can be further used for automatically proposing an alternative path so as to avoid obstacles intelligently in case of coupling with a solver.

1. A method of assisting with the approach of an aircraft for landing on a landing zone, the method being implemented by computer, the method comprising:
an initial calculation step for calculating a reference path linking the current position of the aircraft to the landing zone, the reference path including a lateral path and a vertical profile, the vertical profile comprising an altitude profile, a speed profile, configuration setup points, each configuration setup point corresponding to an operation of aircraft high-lift devices, a deployment point for the landing gear, and, if appropriate, one or a plurality of segments with airbrakes, and the application of a stabilization test to the reference path to determine whether the reference path can be used for the landing;
modification steps implemented successively according to a sequence of modifications, each modification step comprising the calculation of a modification of the reference path according to predefined modification rules specific to the modification step, and the application of the stabilization test to the modified reference path;
a transmitting step comprising transmitting of the reference path to the human pilot(s), to an autopilot and/or to a traffic management system, the transmitting step being implemented as soon as the reference path calculated in the initial calculation step or modified after one or a plurality of modification steps passes the stabilization test.

2. The approach assistance method according to claim 1, comprising the iterative repetition of at least one of the modification steps before going to the next modification step, so as to modify the path by applying several times, the modification rules specific to said modification step repeated several times, the repetition being stopped according to a stop criterion specific to the modification step repeated several times.

3. The approach assistance method according to claim 1, comprising at least one step of modifying by angular adjustment, the lateral path comprising modifying the lateral path (TL), and calculating a new vertical profile according to the modified lateral path.

4. The approach assistance method according to claim 1, comprising at least one step of modification by adjusting the vertical profile, each step of modification by adjusting the vertical profile comprising the modification of the vertical profile, and an adaptation, if appropriate, of the lateral path, made so as to take into account, the modification of the vertical profile.

5. The approach assistance method according to claim 4, comprising at least one step of modification by adjusting the vertical profile, wherein the modification is performed by modifying the speed profile.

6. The approach assistance method according to claim 4, comprising at least one step of modification by adjusting the vertical profile, wherein the modification is performed by modifying the configuration setup positions of the high-lift devices.

7. The approach assistance method according to claim 4, comprising at least one step of modification by adjusting the vertical profile, wherein the modification is performed by adding segments with airbrakes.

8. The approach assistance method according to claim 4, comprising at least one step of modification by adjusting the vertical profile, wherein the modification is performed by modifying the deployment position of the landing gear.

9. The approach assistance method according to claim 1, comprising a step of modification of the lateral path by a trombone-shape adjustment.

10. The approach assistance method according to claim 1, wherein the sequence of modifications comprises sequentially:
a step of modification, by angular adjustment, of the lateral path comprising the modification of the lateral path, and the calculation of a vertical profile according to the modified lateral path; then
a sequence of steps of modification by adjustment of the vertical profile comprising at least one step of modification by adjustment of the vertical profile, each step of modification by adjustment of the vertical profile comprising a modification of the vertical profile and an adaptation, if appropriate, of the lateral path which would take into account the modification of the vertical profile.

11. The approach assistance method according to claim 10, wherein said sequence of steps of modification by adjusting the vertical profile comprises:
a step of modification by adjustment of the vertical profile, wherein the modification is performed by modifying the speed profile;
a step of modification by adjustment of the vertical profile, wherein the modification is made by modifying the configuration setup positions of the high-lift devices;
a modification step by adjusting the vertical profile, wherein the modification is made by adding segments with airbrakes; and/or
a modification step by adjusting the vertical profile, wherein the modification is made by modifying the deployment point of the landing gear.

12. The approach assistance method according to claim 10, comprising a step of modification by trombone-shape adjustment of the lateral path (E4), implemented after the step(s) of modification by adjusting the vertical profile.

13. The approach assistance method according to claim 1, wherein the stabilization test comprises the calculation of a distance required for landing, and the comparison of the distance required with the length of the reference path, the reference path being validated if the length thereof is greater than the required distance.

14. The approach assistance method according to claim 1, wherein the stabilization test comprises the verification of one or a plurality of the following validation conditions, each validation condition being applied to the point of the reference path at which the aircraft must be at the stabilization altitude:
the predicted speed being less than the approach speed recommended by the aircraft flight manual, plus a predefined validation speed margin; and/or
the predicted vertical difference being less than a predefined validation vertical difference; and/or
the predicted vertical speed being consistent with a reference slope plus a predefined validation vertical speed margin; and/or
the landing gear being predicted as being deployed; and/or
the landing configuration being predicted as being spread; and/or
the thrust being not at idle engine speed at the stabilization altitude increased by a validation altitude margin.

15. The approach assistance method according to claim 1, the approach assistance method being implemented periodically and comprising the application of an invalidation test to the last validated and transmitted reference path, and the resumption of the calculation of a reference path if the last transmitted reference path is invalidated by the invalidation.

16. The approach assistance method according to claim 15, wherein each validation condition of the stabilization test is associated with an invalidation condition applying to the same parameter as the validation condition, the validation condition and the invalidation condition being intended for applying a hysteresis to said parameter.

17. The approach assistance method according to claim 15, wherein the calculation of a reference path is resumed at the initial calculation step or is resumed starting from the last transmitted reference path and by resuming at the modification step following the step which determined the last transmitted reference path.

18. The approach assistance method according to claim 15, wherein the stabilization test comprises the calculation of a distance required for landing, and the comparison of the distance required with the length of the reference path, the reference path being validated if the length thereof is greater than the required distance and wherein the invalidation test comprises comparing the difference between a distance required for landing and the length of the reference path, with a predefined difference threshold, the reference path being invalidated if the difference is greater than the difference threshold.

19. The approach assistance method according to claim 14, wherein the approach assistance method is implemented periodically and comprises the application of an invalidation test to the last validated and transmitted reference path, and the resumption of the calculation of a reference path if the last transmitted reference path is invalidated by the invalidation, the invalidation test comprising one or a plurality of the following invalidation conditions, each invalidation condition being applied to the point of the reference path at which the aircraft has to be at the stabilization altitude:
the predicted speed being greater than the approach speed plus a predefined invalidation speed margin strictly greater than the validation speed margin;
the predicted vertical difference being greater than a predefined vertical invalidation difference strictly greater than the vertical validation difference;
the predicted vertical speed being greater than the vertical speed corresponding to the reference slope plus a vertical invalidation speed margin strictly greater than the vertical validation speed margin;
the landing gear being not predicted as being deployed;
the landing configuration being not predicted as being spread;
the thrust being not idling at the stabilization altitude plus an invalidation altitude margin strictly less than the validation altitude margin.

20. An electronic system, configured for implementing an approach assistance method according to claim 1.

21. A non-transitory computer-readable medium on which is stored a computer program which can be saved in a memory and which contains software code instructions for implementing an approach assistance method according to claim 1, when executed by a processor.
